(19) United States
(12) Patent Application Publication
(10) Pub. No.: US 2023/0358638 A1
(43) Pub. Date: Nov. 9, 2023

(54) AERO-ENGINE BEARING FAULT DIAGNOSIS METHOD BASED ON VARIATIONAL MODE DECOMPOSITION AND RESIDUAL NETWORK

(71) Applicant: ZHEJIANG UNIVERSITY CITY COLLEGE, Hangzhou (CN)

(72) Inventors: Anping WAN, Hangzhou (CN); Jie YANG, Hangzhou (CN); Jiantao YUAN, Hangzhou (CN); Jinglin WANG, Hangzhou (CN); Tianmin SHAN, Hangzhou (CN); Zhihua GAN, Hangzhou (CN); Bo WANG, Hangzhou (CN); Ting CHEN, Hangzhou (CN); Guanqun LUO, Hangzhou (CN)

(73) Assignee: ZHEJIANG UNIVERSITY CITY COLLEGE, Hangzhou (CN)

(21) Appl. No.: 17/790,966

(22) PCT Filed: Jan. 25, 2022
(86) PCT No.: PCT/CN2022/073740

§ 371 Date: Jul. 6, 2022

(30) Foreign Application Priority Data
Dec. 30, 2021 (CN) 202111663014.8

(51) Int. Cl. G01M 13/04

(52) U.S. Cl. CPC G01M 13/04

(57) ABSTRACT

An aero-engine bearing fault diagnosis method based on variational mode decomposition and residual network includes the following steps: collect signals in different positions and directions with vibration acceleration sensors, which will be used as sample data; convert the said sample data into the target data type through normalization, slicing, variational mode decomposition and labeling, to get a training sample set; build a 1D-Resnet model, input the training sample set into the said 1D-Resnet model for training and save the model parameters when the model converges; diagnose the aero-engine bearing fault with the trained 1D-Resnet model, to get the diagnostic results. The method diagnoses and analyzes faults of the bearings of the rotating mechanical parts in aero-engines based on variational mode decomposition and residual network, which improves the diagnostic accuracy, and can provide an accurate and reliable basis for maintenance workers.

### CROSS REFERENCE TO THE RELATED APPLICATIONS

This application is the national stage entry of International Application No. PCT/CN2022/073740, filed on Jan. 25, 2022, which is based upon and claims priority to Chinese Patent Application No. 202111663014.8, filed on Dec. 30, 2021, the entire contents of which are incorporated herein by reference.

### TECHNICAL FIELD

The present invention relates to the technical field of fault diagnosis of electromechanical systems, and particularly to an aero-engine bearing fault diagnosis method based on variational mode decomposition and residual network.

### BACKGROUND

Nearly 40% of the navigation accidents in a year are caused by mechanical problems such as equipment system failure, fault, wear and tear of key parts and components. Aero-engine is a key component of an aircraft with the most mechanical parts and the most complex working environment. Any accidental damage of an aero-engine can cause huge accidents and economic losses.

Bearings, as aero-engine rotor supports, work in high-temperature, high-pressure and high-corrosive environments, and are prone to damage such as wear, spalling, and ablation affected by alternating impact loads. Its fault may increase system noise and vibration, and at worst, will cause serious damage to the whole engine and its accessories. If the fault is not detected timely and accurately, there will be great dangers to the safety and efficiency of aerial operations. Therefore, how to monitor the operating status of an aero-engine, diagnose its fault timely and accurately, and predict the occurrence of any fault is of great research significance for the flight safety guarantee.

The traditional manifestation of engine mechanical system faults is vibration. At present, some cases have studied the fault diagnosis of rotating parts such as aero-engine bearings. Most of them are based on the vibration signal analysis method, which is to collect the vibration acceleration signal of engine shell, and extract the time-domain and frequency-domain characteristics of faults through traditional artificial signal analysis. In spite of the guaranteed accuracy, the bearing fault diagnosis based on signal processing shows deficiencies of high dependence on signal knowledge and on manual work during the complex process of feature extraction. In recent years, with the maturity of artificial intelligence technology, research of aero-engine fault diagnosis based on machine learning and deep learning springs up. On the one hand, a large amount of vibration data is stored during the service of aero-engines, which needs to be analyzed and mined. On the other hand, the computers can realize the calculation of larger volume of data with their hardware further improved.

As a consequence, how to diagnose and analyze the fault of bearings of the rotating mechanical parts in aero-engines, and to accurately identify its category is an urgent problem for those skilled in the art.

### SUMMARY

In view of the above, the present invention provides an aero-engine bearing fault diagnosis method based on variational mode decomposition and residual network, which is to collect acceleration signals at different positions of the body under different fault states, and diagnose and analyze the faults of the bearings of the rotating mechanical parts in aero-engines based on variational mode decomposition and one-dimensional residual network, which improves the diagnostic accuracy.

In order to achieve the above purpose, the present invention provides an aero-engine bearing fault diagnosis method based on variational mode decomposition and residual network, which comprises the following steps:

Collect signals in different positions and directions with vibration acceleration sensors, which will be used as sample data;

Convert the said sample data into the target data type through normalization, slicing, variational mode decomposition and labeling, to get a training sample set;

Build a 1D-Resnet model, input the said training sample set into the said 1D-Resnet model for training and save the model parameters when the model converges;

Diagnose the aero-engine bearing fault with the trained 1D-Resnet model, to get the diagnostic results.

Optionally, the said normalization is maximum and minimum normalization, with the expression of:

$${X}_{n o r m} = \frac{X - {X}_{min}}{{X}_{max} - {X}_{min}} ; \qquad ( 1 )$$

Wherein, Xₘₐₓ is the maximum value of the sample data, Xₘᵢₙ is the minimum value of the sample data, Xₙₒᵣₘ is the normalized result, and [0,1] is the numerical interval.

Optionally, the specific operation of the said slicing is to divide the acceleration signals of the long signal wave every N points to get multiple pieces of short signal wave data of the same length.

Optionally, the specific operation of the said slicing is to amplify the said sample data by overlapping sampling, and segment it every M step length. There is overlap between adjacent sliced data.

Optionally, the specific operation of performing variational mode decomposition on the sliced data is as follows:

Decompose the sliced original one-dimensional signal f(t) into k intrinsic mode functions with limited bandwidth, and extract the frequency-domain characteristics of the signal. The expression of the constrained variation is:

$${min}_{\{ {u}_{k} \} , \{ {w}_{k} \}} \{ {\sum }_{k} {‖ {\partial }_{t} [ ( δ ( t ) + j / π t ) * {u}_{k} ( t ) ] {e}^{- {jw}_{k}^{t}} ‖}_{2}^{2} \} ; \qquad ( 2 )$$

$$s . t . {\sum }_{k = 1}^{K} {u}_{k} = f ; \qquad ( 3 )$$

The expression of the intrinsic mode functions is:

uₖ(t)=aₖ(t)cos(φₖ(t)) (4);

Wherein, k is the number of decomposed modes, {uₖ}={u₁, . . . , uₖ} presents k intrinsic mode functions, {wₖ}={w₁, . . . , wₖ} is the center frequency of each function, δ(t) is the Dirichlet function, * is the convolution operation, t is the time series, aₖ(t) is the non-negative envelope, φₖ(t) is the phase, ∂ₜ represents the partial derivative of time t, K is the total number of modes, and j is the imaginary number in the Fourier transform process.

Introduce quadratic penalty factor α and Lagrange multiplication operator λ, and transform the constrained variational problem into an unconstrained variational problem. The augmented Lagrange expression is:

$$L ( \{ {u}_{k} \} , \{ {w}_{k} \} , λ ) = α {\sum }_{k} {‖ {\partial }_{t} [ ( δ ( t ) + j / π t ) * {u}_{k} ( t ) ] {e}^{- {jw}_{k}^{t}} ‖}_{2}^{2} + {‖ f ( t ) - {\sum }_{k} {u}_{k} ( t ) ‖}_{2}^{2} + 〈 λ ( t ) , f ( t ) - {\sum }_{k} {u}_{k} ( t ) 〉 ; \qquad ( 5 )$$

Wherein, λ(t) represents the Lagrange multiplier.

Optionally, the specific operation of the said labeling processing is to add corresponding fault labels of 0-i to the data after variational mode decomposition, where i is the total number of categories. Optionally, the constructed 1D-Resnet model comprises an input layer, 5 residual modules, a Dropout layer, a Flatten layer and an output layer; The first residual module comprises a one-dimensional convolutional layer and a one-dimensional maximum pooling layer;

The second residual module comprises two identity modules; for each identity module, the main road consists of two one-dimensional convolutional layers connected in series, and the branch is an identity mapping channel;

The third, fourth and fifth residual modules consist of an identity module and a convolutional downsampling module connected in series; the main road of the convolutional downsampling module consists of two one-dimensional convolutional layers connected in series, and the branch is a convolution layer with a convolution kernel size of 1.

Optionally, the training of the said 1D-Resnet model specifically comprises the following steps:

Input a multi-channel one-dimensional vector through the said input layer and input the said multi-channel one-dimensional vector into the residual module; the number of channels=the number of sensors*the number of intrinsic modes k after variational mode decomposition;

Convolute the output of the upper layer through the convolutional layer in the said residual module, and extract the spatial features of a local area by using the nonlinear activation function. The mathematical model is expressed as:

yᵢ^{l+1}(j)=wᵢ^{l}·x^{l}(j)+bᵢ^{l} (6);

zᵢ^{l+1}(j)=f(yᵢ^{l+1}(j)) (7);

Wherein, yᵢ^{l+1}(j) represents the input of the j^{th} neuron in layer l+1, that is, the output of layer l; wᵢ^{l} represents the weight of the i^{th} filter kernel in layer l, the symbol · represents the dot product of the kernel and the local area, x^{l}(j) represents the input of the j^{th} neuron in layer l, bᵢ^{l} represents the bias of the i^{th} filter kernel in layer l, zᵢ^{l+1}(j) represents the result of the i^{th} filter kernel in layer l+1 under the action of the nonlinear activation function, and f(⋅) represents the activation function. The logical value output of each convolution is transformed nonlinearly.

Reduce network parameters through the maximum pooling layer in the residual module, and lessen the data length through the said convolutional downsampling module;

Randomly discard the parameters trained by the residual module through the said Dropout layer;

Integrate the local information distinguished by the residual module through the said Flatten layer to get single channel data;

Back-propagate the data output from the output layer with the softmax function to optimize the 1D-Resnet model until the model converges. The trained 1D-Resnet model is obtained.

Optionally, the specific operation of getting the diagnostic results is as follows:

Convert the acceleration signal of the aero-engine to be detected into the target data type and input it into the trained 1D-Resnet model, to get the probability value of each fault category, and take the fault label corresponding to the maximum probability value as the final fault category identification result.

According to the above technical scheme, compared with the prior art, the present invention provides an aero-engine bearing fault diagnosis method based on variational mode decomposition and residual network, which has the following beneficial effects:
(1) The present invention can decompose the original signal into different intrinsic modes by variational mode decomposition, which is beneficial to enhance the fault characteristics and improve the signal-to-noise ratio;
(2) The present invention can directly perform feature mining on time-domain signals based on one-dimensional residual network, and extract the spatial and temporal features of signal data, which is helpful in improving the accuracy of aero-engine bearing fault diagnosis;
(3) In addition, it can get better identification result and improve the diagnosis accuracy by collecting the acceleration signals at different positions of the aero-engine under different fault states and training the 1D-Resnet model, so the maintainers can rely on accurate and reliable data.

### BRIEF DESCRIPTION OF THE DRAWINGS

To better describe the embodiment of the present invention or the technical scheme of the prior art, a brief introduction of the accompanying drawings to be used in the descriptions of the embodiment or the prior art is made hereby. Obviously, the drawings below are only the embodiment of the present invention, and for those ordinarily skilled in the art, other drawings based on such drawings can be obtained without making creative endeavors.

FIG. 1 is a flowchart of aero-engine bearing fault diagnosis based on variational mode decomposition and residual network;

FIG. 2 is a flowchart of data preprocessing;

FIG. 3 is a structural diagram of the 1D-Resnet model;

FIG. 4 is the comparison diagram of the accuracy rates of the fault diagnosis method in the present invention and other methods;

FIG. 5 shows the confusion matrix of fault diagnostic results of group 1 verification set.

### DETAILED DESCRIPTION OF THE EMBODIMENTS

The technical scheme in the embodiment of the present invention is clearly and completely described below in combination with the drawings of the embodiment of the present invention. Obviously, the embodiment is just a part of embodiments of the present invention, not all of them. Based on the embodiment of the present invention, all the other embodiments obtained by those ordinarily skilled in the art without making creative endeavors shall fall into the scope of protection of the present invention.

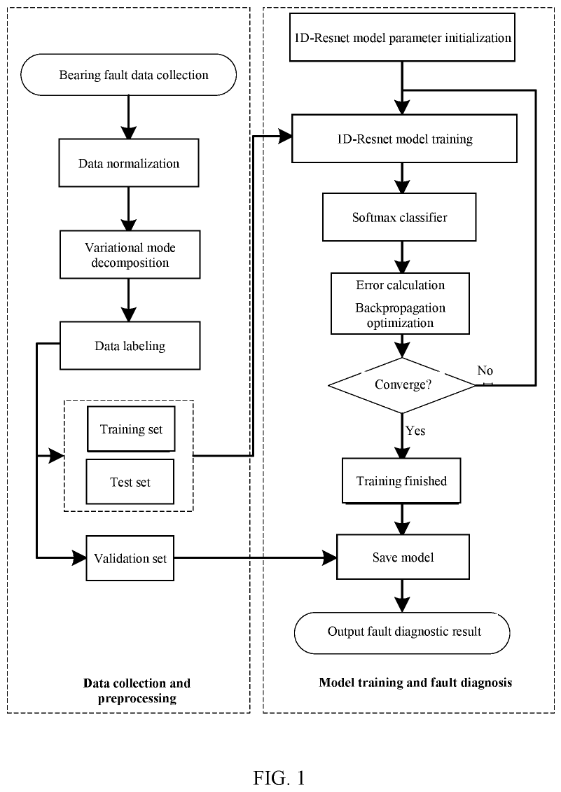

The embodiment of the present invention discloses an aero-engine bearing fault diagnosis method based on variational mode decomposition and residual network, as shown in FIG. 1, which comprises the following steps:

### (1) Data Collection

Collect signals in different positions and directions with vibration acceleration sensors according to the needs, and use such signals as sample data;

Specifically, in this embodiment, the relevant data of the deep groove ball bearing for the test of the main reducer test bench of a helicopter transmission system is collected. The detected faulty bearing is installed at the entrance of the drive shaft into the gearbox, and the acceleration sensor is located on the gearbox casing. The speed sensor collects the output speed of the motor (constant), at the sampling frequency of 10,000 Hz. Data is collected for one minute in three periods: startup, smooth operation and coining to a stop, and the data of each minute is set as a group. Bearing faults include rolling element, inner ring, outer ring, and combined faults. Single-point faults (single-point holes with a diameter of 0.1 mm) are set in corresponding parts with EDM technology.

### (2) Data Preprocessing

Convert the sample data into the target data type through normalization, slicing, variational mode decomposition and labeling to get a training sample set, which specifically comprises the following steps:

First, normalization is maximum and minimum normalization, with the expression of:

$${X}_{n o r m} = \frac{X - {X}_{min}}{{X}_{max} - {X}_{min}} ; \qquad ( 1 )$$

Wherein, Xₘₐₓ is the maximum value of the sample data, Xₘᵢₙ is the minimum value of the sample data, Xₙₒᵣₘ is the normalized result, and [0,1] is the numerical interval.

Further, the specific operation of data slicing is to divide the long signal wave every N points to get multiple pieces of short signal wave data of the same length. If a small amount of fault data is collected, the sample data can be amplified by overlapping sampling. The data is divided every M step lengths, and there is overlap between adjacent sliced data.

Further, the variational mode decomposition is to have modal decomposition of the sliced data by the VIVID method in the vmdpy library in python. VIVID is a new self-adaptive and completely non-recursive mode variation and signal processing method, which avoids the influence of signal length selection on decomposition results. The decomposition is essentially a process of finding the optimal solution of the constrained variational problem. The original one-dimensional signal f(t) is decomposed into k intrinsic mode functions (IMF for short) with limited bandwidth, and the constraint is that the sum of the estimated bandwidths of the modes is the smallest, and the sum of all modes is equal to the original signal. The expression of the constraint variation is:

$${min}_{\{ {u}_{k} \} , \{ {w}_{k} \}} \{ {\sum }_{k} {‖ {\partial }_{t} [ ( δ ( t ) + j / π t ) * {u}_{k} ( t ) ] {e}^{- {jw}_{k}^{t}} ‖}_{2}^{2} \} ; \qquad ( 2 )$$

$$s . t . {\sum }_{k = 1}^{K} {u}_{k} = f ; \qquad ( 3 )$$

The expression of the intrinsic mode functions is:

uₖ(t)=aₖ(t)cos(φₖ(t)) (4);

Wherein, k is the number of decomposed modes, {uₖ}={u₁, . . . , uₖ} presents k intrinsic mode functions, {wₖ}={w₁, . . . , wₖ} is the center frequency of each function, δ(t) is the Dirichlet function, * is the convolution operation, t is the time series, aₖ(t) is the non-negative envelope, φₖ(t) is the phase, ∂ₜ represents the partial derivative of time t, K is the total number of modes, and j is the imaginary number in the Fourier transform process.

Introduce quadratic penalty factor α (to reduce the interference of Gaussian noise) and Lagrange multiplication operator λ, and transform the constrained variational problem into an unconstrained variational problem. The augmented Lagrange expression is:

$$L ( \{ {u}_{k} \} , \{ {w}_{k} \} , λ ) = α {\sum }_{k} {‖ {\partial }_{t} [ ( δ ( t ) + j / π t ) * {u}_{k} ( t ) ] {e}^{- {jw}_{k}^{t}} ‖}_{2}^{2} + {‖ f ( t ) - {\sum }_{k} {u}_{k} ( t ) ‖}_{2}^{2} + 〈 λ ( t ) , f ( t ) - {\sum }_{k} {u}_{k} ( t ) 〉 ; \qquad ( 5 )$$

Wherein, λ(t) represents the Lagrange multiplier.

When performing the variational mode decomposition, it is necessary to define the number of decomposition modes k and the bandwidth limit a, where k is generally 5 or 7, and the empirical value of a is 1.5-2.0 times the length of the slice sample.

In the fault diagnosis of rotating parts such as aero-engine bearings, VMD can be used to decompose the vibration acceleration signal containing Gaussian white noise, and then preliminarily extract the frequency-domain features of the signal, which enhances the frequency representation of fault features in the signal, and improving the effect of bearing fault diagnosis.

Further, the specific operation of labelling is to add corresponding fault labels of 0-i to the data after variational mode decomposition, where i is the total number of categories.

Further, an aero-engine fault database management system is established with SQL Server database technology to realize data interaction and effective storage.

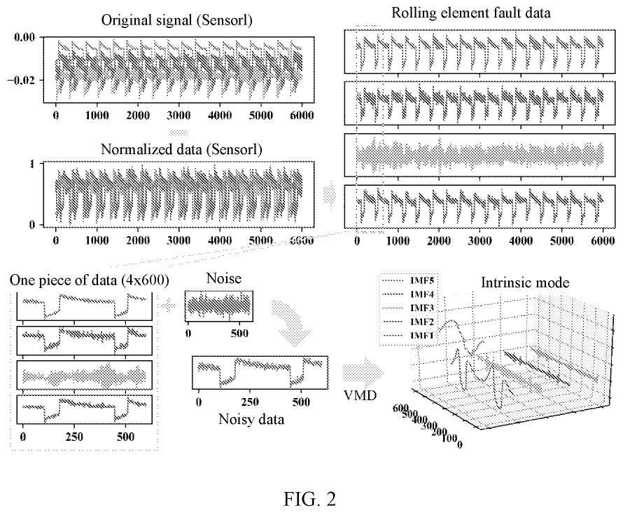

In this embodiment, the data collected in the first part is preprocessed as above (see FIG. 2 for the flowchart), and is converted into a data type that can be used for supervised learning. The data structure of the bearing dataset is shown in Table 1.

TABLE 1
Bearing dataset

| | Training | Test | Validation | Sample | Category |
|---|---|---|---|---|---|
| Fault category | set | set | set | length | label |
| Rolling element | 1600 | 400 | 200 | 600 | 0 |
| fault | | | | | |
| Joint fault | 1600 | 400 | 200 | 600 | 1 |
| Inner ring fault | 1600 | 400 | 200 | 600 | 2 |
| Outer ring fault | 1600 | 400 | 200 | 600 | 3 |
| Normal | 1600 | 400 | 200 | 600 | 4 |

Take the data collected in the first and second minutes as the training set and test set, which are respectively used for training model iteration and testing the model accuracy change during training. The data collected in the third minute is set as the verification set, used for testing the generalization effect of the model.

### (3) Model Training

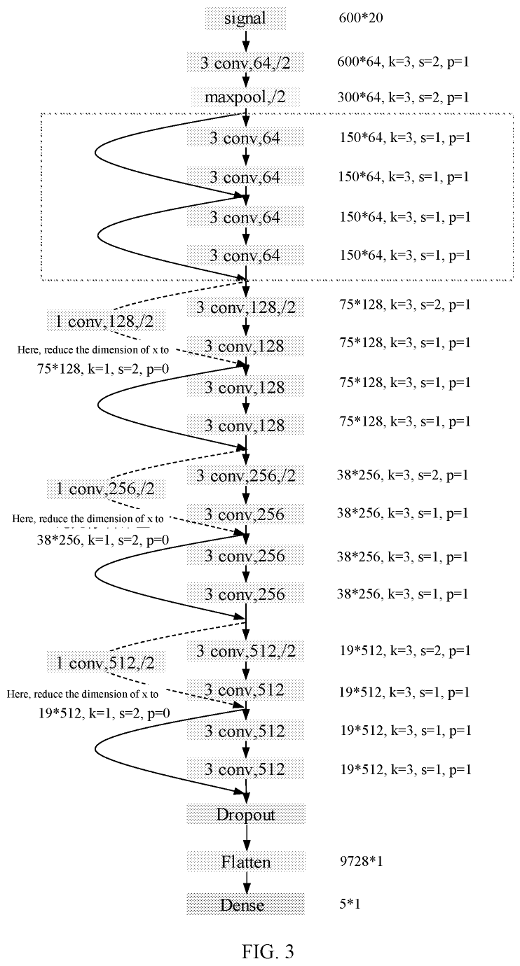

According to the principle of 1D-Resnet neural network, the specific structure of the aero-engine bearing fault diagnosis model proposed by the present invention is shown in FIG. 3. The model is modified from the well-known residual network Resnet18 in the field of image recognition. Conv_2D layer and MaxPooling2D layer for two-dimensional image convolution are modified to Conv_1D layer and MaxPooling1D layer suitable for one-dimensional signal feature mining, and the corresponding parameters are modified to adapt to the dataset of this study.

The network model in this embodiment consists of an input layer, 5 residual modules, a Dropout layer, a Flatten layer and an output layer. The input data is a multi-channel one-dimensional vector with a length of 600 and a number of channels of 20 (the number of channels=the number of sensors*the number of intrinsic modes k after variational mode decomposition).

The first residual module (Conv1) consists of a one-dimensional convolutional layer (with a size of 3, 64 convolution kernels, a sliding step length of 2, and 3 units of zero-padding) and a maximum pooling layer (with a pooling area size of 3, a sliding step length of 2, and 1 unit of zero-padding). The second residual module (Conv_2x) consists of two identity modules. For each identity module, the main road consists of two one-dimensional convolutional layers connected in series, and the branch is an identity mapping channel The convolutional layers consist of 64 convolution kernels with a size of 3, a sliding step length of 1, and 1 unit of zero-padding. The third, fourth and fifth residual modules consist of an identity module and a convolutional downsampling module connected in series. The main road of the convolutional downsampling module consists of two one-dimensional convolutional layers connected in series, and the branch is a convolution layer with a convolution kernel size of 1, a sliding step length of 2, and non-zero padding.

The convolution kernel of the convolutional layer in the residual module convolutes the output of the previous layer, to extract the spatial features of the local area, and obtain the characteristic mapping with a width of W×, a height of 1×and a depth of D. In this process, a nonlinear activation function is usually used to construct the output features, and its mathematical model is expressed as:

yᵢ^{l+1}(j)=wᵢ^{l}·x^{l}(j)+bᵢ^{l} (6);

zᵢ^{l+1}(j)=f(yᵢ^{l+1}(j)) (7);

Wherein, yᵢ^{l+1}(j) represents the input of the j^{th} neuron in layer l+1, that is, the output of layer l; wᵢ^{l} represents the weight of the i^{th} filter kernel in layer l, the symbol · represents the dot product of the kernel and the local area, x^{l}(j) represents the input of the j^{th} neuron in layer l, bᵢ^{l} represents the bias of the i^{th} filter kernel in layer l, zᵢ^{l+1}(j) represents the result of the i^{th} filter kernel in layer l+1 under the action of the nonlinear activation function, and f(⋅) represents the activation function. The logical value output of each convolution is transformed nonlinearly, and the original linear and indivisible multidimensional features are transformed into another space to enhance the linear separability of features.

The maximum pooling layer is to reduce the network parameters, and the convolutional downsampling module is to lessen the data length and reduce the amount of data. Generally, maximum pooling or average pooling is used, and the maximum value of the perception domain is taken as the output characteristic mapping.

The Dropout layer randomly discards the previously trained parameters. Generally, the retention rate is set to 0.8, which means 20% of the parameters are discarded to prevent excessive model parameters and training resource over-consumption.

The Flatten layer is a fully connected layer. It expands the output of the last residual module into a one-dimensional vector, establishes a fully connected network between the input and output, integrates the local information distinguished by the residual module, compresses the multi-channel one-dimensional data to single-channel one-dimensional data, and then transfer the data to the Softmax classifier for classification.

Softmax classifier is usually used in the output layer to distinguish labels, and the output results are the probability values of the categories. The label corresponding to the largest probability value is taken as the recognition result.

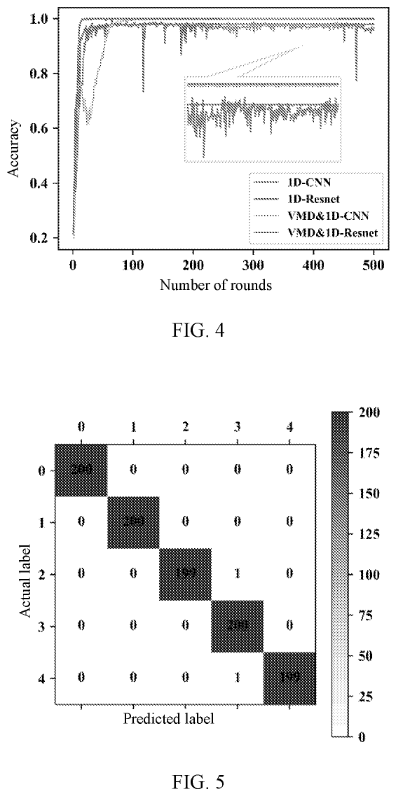

Next, the method proposed in this study is tested against several other methods, see FIG. 4.

Specifically, targeted at the problem of aero-engine bearing fault diagnosis, in this embodiment, the original noise-added data (4×600) that is not decomposed by VIVID is selected and input into 1D-Resnet, VMD&1D-CNN, and the single 1D-CNN method as a comparison. The values when the recognition effect is optimal are taken as their structure and parameters. To control the learning rate of the network, the Adam (Adaptive Momentum Estimation) optimization algorithm is used to update the network parameters, and the initial learning rate is set to 0.0001. The Dropout regularization method is introduced in the fully connected layer to avoid training data overfitting, and the retention rate is 0.8. The neural network training parameters are set as follows: maximum number of iterations epoch=500, mini-batch size Batch size=64. The total number of network parameters of the model is 3,936,709, each iteration takes 4.001 s, and the total training time is 33.342 min.

This embodiment was implemented on a computer conFIGured with an NVIDIA GeForce GTX1650 and 16-GB RAM, and a programming language of Python, in an integrated development environment of Spyder, TensorFlow 2.1.1, and Keras 2.3.1, all of which are open-source deep learning platforms or software libraries for developing the proposed model.

According to FIG. 4, in the early stage of model training, each model shows a fast convergence, and the method proposed by the present invention is the fastest, which converges to a stable state in 18 rounds. VIVID&1D-CNN indicates a sudden drop in accuracy. Compared with 1D-CNN without VMD, the reason for this is that the increase in data dimensions leads to the overfitting of the convolutional neural network to the training set, and the learning of additional features undermines the accuracy of the test set. In the subsequent training, the useless features are discarded, so the accuracy returns to normal.

After converging to the optimal accuracy rate of the model, the method proposed by the present invention remains stable until the 500^{th} round, while the method using only 1D-CNN causes repeated oscillations of the accuracy rate, which adversely affects the final diagnosis effect.

Generally, accuracy, precision and recall rate are the evaluation criteria for model identification. Accuracy refers to the ratio of the number of samples correctly classified by the classifier to the total number of samples for a given test set, which is presented by the visualization tool that comes with the model; precision (P) refers to the ratio of the number of samples correctly classified as label A to the total number of samples classified as label A; recall rate (R) refers to the ratio of the number of samples correctly classified as label A to the number of samples actually of A category in the samples. The calculation formulas are as follows:

$$P = \frac{TP}{TP + FP} ; \qquad ( 8 )$$

$$R = \frac{TP}{TP + FN} ; \qquad ( 9 )$$

Wherein, TP is the number of samples that are correctly classified as A, FP is the number of samples that are classified as A but are actually not A, and FN is the number of samples that are actually A but are incorrectly classified.

In this embodiment, each model is continuously trained for five times. The specific values of the accuracy of the diagnosis methods are shown in Table 2. VMD and 1D-Resnet have achieved a 100% identification, while other algorithm models show certain errors. Aero-engine bearing fault diagnosis methods shall ensure high precision, otherwise there will be a great safety hazard for aloft workers.

TABLE 2
Accuracy

| Model | 1 | 2 | 3 | 4 | 5 |
|---|---|---|---|---|---|
| 1D-CNN | 0.962 | 0.972 | 0.960 | 0.957 | 0.966 |
| 1D-Resnet | 0.979 | 0.980 | 0.961 | 0.980 | 0.974 |
| VMD&1D-CNN | 0.997 | 0.989 | 0.998 | 1 | 0.998 |
| VMD&1D-Resnet | 1 | 1 | 1 | 1 | 1 |

To further test the effectiveness of the method proposed by the present invention, five verification sets are sequentially input into the trained model for fault diagnosis. The diagnosis accuracy and identification speed are shown in Table 3.

TABLE 3
Fault diagnosis effect

| Group No. | Accuracy | Identification speed |
|---|---|---|
| 1 | 99.8% | 2.234 s |
| 2 | 100% | 2.191 s |
| 3 | 99.8% | 2.190 s |
| 4 | 99.7% | 2.131 s |
| 5 | 100% | 1.911 s |

Due to different acquisition time, there is a certain difference in data distribution between the validation set and the training set, but after variational mode decomposition, the original vibration acceleration signal is decomposed into multiple intrinsic modes with different center frequencies. The high-frequency impact characteristics reflecting the fault characteristics are amplified thereby, so the overall identification accuracy is significantly improved to nearly 100%. At the same time, in this model, the identification time of 1,000 pieces of data in each group is 1.911 s. As a result, in case of a sudden failure or potential fault during high-altitude operation, the workers have enough time to adjust the operating status of the equipment, so as to avoid serious consequences. According to the confusion matrix of the classification results of group 1 in FIG. 5, the precisions of the five categories are 100%, 100%, 100%, 99%, and 100%, respectively, and the recall rates are 100%, 100%, 99.5%, 100%, 99.5%. Under the conditions of inner ring fault and normal bearing, there is a signal that is mistakenly identified as an outer ring fault. During the running of an aviation main reducer, the loss caused by mistaking a normal bearing as a fault is much smaller than that of identifying a faulty bearing as a normal one. Therefore, the practicability of the method proposed by the present invention is verified.

In the practical application scenario, the workers can install the acceleration sensors at the designated positions of the aero-engine, to collect its vibration signal during operation, which will be integrated and preprocessed, and put into the fault diagnosis model proposed by the present invention. Consequently, any fault in the current equipment and its category can be identified, providing an accurate and reliable basis for the maintenance workers.

The above description of the disclosed embodiment enables those skilled in the art to practice or use the present invention. Modifications to the embodiment will be apparent to those skilled in the art, and the general principles defined herein can be implemented in other embodiments without departing from the essence or scope of the present invention. Accordingly, the present invention will not be limited to the embodiment described herein, but will cover the widest scope consistent with the principles and novel features disclosed herein.

What is claimed is:

1. An aero-engine bearing fault diagnosis method based on variational mode decomposition and residual network, comprising the following steps:
collecting signals in different positions and directions with vibration acceleration sensors, wherein the signals are used as sample data;
converting the said sample data into a target data type through normalization, slicing, variational mode decomposition and labeling, to get a training sample set;
building a 1D-Resnet model, inputting the said training sample set into the said 1D-Resnet model for training and saving model parameters when the 1D-Resnet model converges to obtain a trained 1D-Resnet model; and
diagnosing an aero-engine bearing fault with the trained 1D-Resnet model, to get the diagnostic results.

2. The aero-engine bearing fault diagnosis method according to claim 1, wherein the said normalization is maximum and minimum value normalization, with an expression of
$${X}_{n o r m} = \frac{X - {X}_{min}}{{X}_{max} - {X}_{min}} ; \qquad ( 1 )$$
wherein, Xₘₐₓ is a maximum value of the sample data, Xₘᵢₙ is a minimum value of the sample data, Xₙₒᵣₘ is a normalized result, and [0,1] is a numerical interval.

3. The aero-engine bearing fault diagnosis method according to claim 1, wherein a specific operation of the said slicing is to divide acceleration signals of a long signal wave every N points to get multiple pieces of short signal wave data of the same length.

4. The aero-engine bearing fault diagnosis method according to claim 1, wherein a specific operation of the said slicing is to amplify the said sample data by overlapping sampling, and segment the said sample data every M step length, wherein there is overlap between adjacent sliced data.

5. The aero-engine bearing fault diagnosis method according to claim 1, wherein a specific operation of the variational mode decomposition of sliced data comprises:
decomposing a sliced original one-dimensional signal f(t) into k intrinsic mode functions with a limited bandwidth, and extracting frequency-domain characteristics of the sliced original one-dimensional signal, wherein an expression of a constrained variation is:
$${min}_{\{ {u}_{k} \} , \{ {w}_{k} \}} \{ {\sum }_{k} {‖ {\partial }_{t} [ ( δ ( t ) + j / π t ) * {u}_{k} ( t ) ] {e}^{- {jw}_{k}^{t}} ‖}_{2}^{2} \} ; \qquad ( 2 )$$
$$s . t . {\sum }_{k = 1}^{K} {u}_{k} = f ; \qquad ( 3 )$$
an expression of the k intrinsic mode functions is:
uₖ(t)=aₖ(t)cos(φₖ(t)) (4);
wherein, k is a number of decomposed modes, {uₖ}={u₁, . . . , uₖ} presents the k intrinsic mode functions, {wₖ}={w₁, . . . , wₖ} is a center frequency of each function, δ(t) is a Dirichlet function, * is a convolution operation, t is a time series, aₖ(t) is a non-negative envelope, φₖ(t) is a phase, ∂ₜ represents a partial derivative of time t, K is a total number of modes, and j is an imaginary number in a Fourier transform process;
introducing a quadratic penalty factor α and a Lagrange multiplication operator λ, and transforming a constrained variational problem into an unconstrained variational problem, wherein an augmented Lagrange expression is:
$$L ( \{ {u}_{k} \} , \{ {w}_{k} \} , λ ) = α {\sum }_{k} {‖ {\partial }_{t} [ ( δ ( t ) + j / π t ) * {u}_{k} ( t ) ] {e}^{- {jw}_{k}^{t}} ‖}_{2}^{2} + {‖ f ( t ) - {\sum }_{k} {u}_{k} ( t ) ‖}_{2}^{2} + 〈 λ ( t ) , f ( t ) - {\sum }_{k} {u}_{k} ( t ) 〉 ; \qquad ( 5 )$$
wherein, λ(t) represents a Lagrange multiplier.

6. The aero-engine bearing fault diagnosis method according to claim 1, wherein a specific operation of the said labeling is to add corresponding fault labels of 0-i to the sample data after the variational mode decomposition, where i is a total number of categories.

7. The aero-engine bearing fault diagnosis method according to claim 1, wherein the 1D-Resnet model comprises an input layer, first to fifth residual modules, a Dropout layer, a Flatten layer and an output layer;
the first residual module comprises a one-dimensional convolutional layer and a one-dimensional maximum pooling layer;
the second residual module comprises two identity modules; a main road of each identity module consists of two one-dimensional convolutional layers connected in series, and a branch of each identity module is an identity mapping channel;
each of the third, fourth and fifth residual modules consists of an identity module and a convolutional downsampling module connected in series; a main road of the convolutional downsampling module consists of two one-dimensional convolutional layers connected in series, and a branch of the convolutional downsampling module is a convolution layer with a convolution kernel size of 1.

8. The aero-engine bearing fault diagnosis method according to claim 7, wherein the said training of the 1D-Resnet model specifically comprises the following steps:
inputting a multi-channel one-dimensional vector through the said input layer and inputting the said multi-channel one-dimensional vector into the first to fifth residual modules; wherein, a number of channels=a number of sensors*a number of intrinsic modes k after the variational mode decomposition;
convoluting an output of an upper layer through the one-dimensional convolutional layers in the said first to fifth residual modules, and extracting spatial features of a local area by using a nonlinear activation function, wherein a mathematical model is expressed as:
yᵢ^{l+1}(j)=wᵢ^{l}·x^{l}(j)+bᵢ^{l} (6);
zᵢ^{l+1}(j)=f(yᵢ^{l+1}(j)) (7);
wherein, yᵢ^{l+1}(j) represents an input of a j^{th} neuron in a layer l+1, that is, the output of a layer l; wᵢ^{l} represents a weight of an i^{th} filter kernel in the layer l, a symbol · represents a dot product of a kernel and the local area, x^{l}(j) represents an input of a j^{th} neuron in the layer l, bᵢ^{l} represents a bias of the i^{th}filter kernel in layer l, zᵢ^{l+1}(j) represents a result of the i^{th} filter kernel in the layer l+1 under the action of the nonlinear activation function, and f(⋅) represents an activation function, a logical value output of each convolution is transformed nonlinearly;
reducing network parameters through the one-dimensional maximum pooling layer in the first residual module, and lessening a data length through the said convolutional downsampling module;
randomly discarding parameters trained by the first to fifth residual modules through the said Dropout layer;
integrating local information distinguished by the first to fifth residual modules through the said Flatten layer to get single channel data;
back-propagating the single channel data output from the output layer with a softmax function to optimize the 1D-Resnet model until the 1D-Resnet model converges, and obtaining the trained 1D-Resnet model.

9. The aero-engine bearing fault diagnosis method according to claim 1, wherein a specific operation of getting the diagnostic results comprises:
converting an acceleration signal of the aero-engine to be detected into the target data type and inputting the acceleration signal into the trained 1D-Resnet model, to get a probability value of each fault category, and
taking a fault label corresponding to a maximum probability value as a final fault category identification result.
